(19) United States
(12) Patent Application Publication
(10) Pub. No.: US 2010/0242512 A1
(43) Pub. Date: Sep. 30, 2010

(54) CONTROL UNIT, IN PARTICULAR FOR A COOLING-AIR FAN OF AN INTERNAL COMBUSTION ENGINE, AND COOLING SYSTEM FOR AN INTERNAL COMBUSTION ENGINE

(75) Inventors: Werner Fleskes, Buehl-Altschweier (DE); Manfred Burkart, Iffezheim (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/520,760

(22) PCT Filed: Oct. 25, 2007
(86) PCT No.: PCT/EP07/61453

§ 371 Date: Jun. 7, 2010

(30) Foreign Application Priority Data
Dec. 21, 2006 (DE) 10 2006 060 624.8

(51) Int. Cl. F25D 17/06; H01H 71/16

(52) U.S. Cl. 62/186; 337/36

(57) ABSTRACT

The invention relates to a control unit (16), in particular for a cooling-air fan (14) of an internal combustion engine (2), having a housing, in which a printed circuit board is arranged, for receiving electronic components and conductor elements (22a, 22b; 22′a, 22′b) are arranged for the supply of current. It is proposed that a temperature fuse (22c, 22′c) is arranged between the conductor elements (22a, 22b; 22′a, 22′b) as an overheating safeguard for the control unit (16).

Control unit, in particular for a cooling-air fan of an internal combustion engine as well as a cooling system for an internal combustion engine.

The present invention is based on a control unit, in particular for a cooling-air fan according to the characteristics of the generic term of claim 1 as well as a cooling system for an internal combustion engine of a motor vehicle according to the characteristics of the generic term of claim 4.

DE 103 21 732 A1 illustrates and describes a cooling-air fan device for an internal combustion engine of a motor vehicle, at which two fans are provided for cooling the engine, which are controlled by a common electric control unit. For cooling the electric control unit an additional air outlet is arranged so that even in the case of a failure of one fan the electric control unit is cooled by the air current of the other fan.

It is furthermore known that a battery voltage is permanently applied at the control units for cooling-air fans of internal combustion engines. This so-called continuous plus clamp (also B+ or clamp 30) ensures that electric power is available even at an integrated or clamped battery, if the ignition is turned off and the ignition key removed. Due to the continuous plus clamp it is ensured that even after turning off the motor vehicle a fan or cooling-air fan caster takes place, which ensures the cooling of the internal combustion engine even in idleness.

Independent of the fact whether a cooling-air fan is equipped with one or several fans, an overheating of the control unit can occur in the case of an error. Thus the entering of moisture into the control unit can cause the creation of salt bridges between different potentials. Over these salt bridges it can come to a short current, which can cause an overheating of this area and therefore an overheating or even fire of the control unit.

The previously described problem cannot only occur at the control unit for the cooling-air fan but generally at control units in motor vehicles, at which a battery or supply voltage is permanently applied—as described previously—for example at ABS engine control units.

It is the task of the invention to ensure that in the exemplarily stated failure cases the control unit is safely protected against overheating.

The solution of this task takes place by the characteristics that are stated in claims 1 and 4.

By integrating a temperature fuse in the current supply that is provided in the control unit it is ensured, that it is switched voltage-free at a certain temperature in the control unit and therefore the current supply is permanently interrupted.

The sub-claims contain further advantageous embodiments and improvement of the control unit for a cooling-air fan of an internal combustion engine according to the invention as well as the cooling system for an internal combustion engine of a motor vehicle according to the invention.

The temperature fuse is construed advantageously as fuse wire, zinc bridge or bimetal element.

The temperature fuse is simply fixed at the conductor elements for the current supply of the control unit with the aid of weld, solder or a cut-clamp connection.

### DRAWINGS

One embodiment of the invention is further explained in the subsequent description and drawings.

It is shown:

FIG. 1 a schematic illustration of a cooling-agent circuit of an internal combustion engine and

FIG. 2 a perspective partial view on the lower housing part of a control unit in the area of the current supply for the conductor printed circuit boards.

### DESCRIPTION OF THE EMBODIMENTS

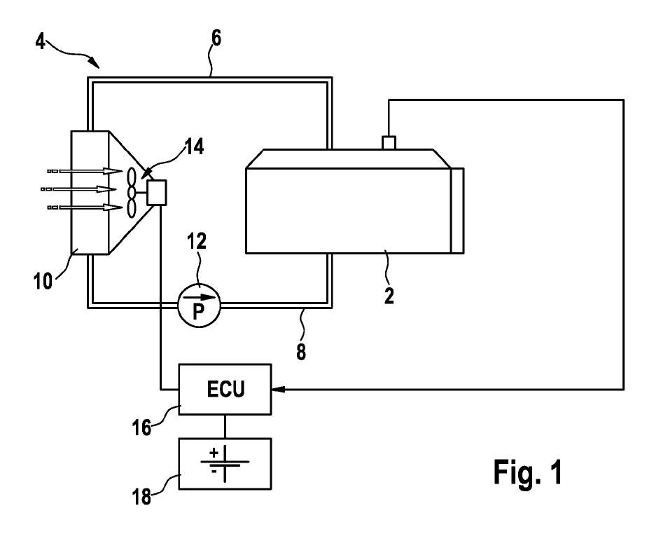

FIG. 1 schematically shows the cooling-agent circuit for the internal combustion engine 2, which consists of a small cooling-agent circuit (not shown) that is integrated in the engine and cylinder head of the internal combustion engine 2 and a big cooling cooling-agent circuit 4. The big cooling-agent circuit 4 consists of an inlet 6 and a return 8, whereby a heat transformer (cooler) 10 is arranged between inlet 6 and return 8. In the return 8 of the big cooling-agent circuit 4 a cooling-agent pump 12 is furthermore provided for creating a cooling-agent forced circulating current.

In order to achieve a more effective heat transformation by a forced convection a cooling-air fan—in the following called fan 14—arranged at the heat transformer 10. The fan 14 is thereby controlled by a control unit 16, which is supplied with board voltage by a vehicle battery 18—even in turned-off state (ignition off). In the present embodiment the control unit 16 is exclusively provided for controlling the fan 14; for cooling the control unit 16 the latter is directly attached at the fan case—preferably in the air current of the fan 14.

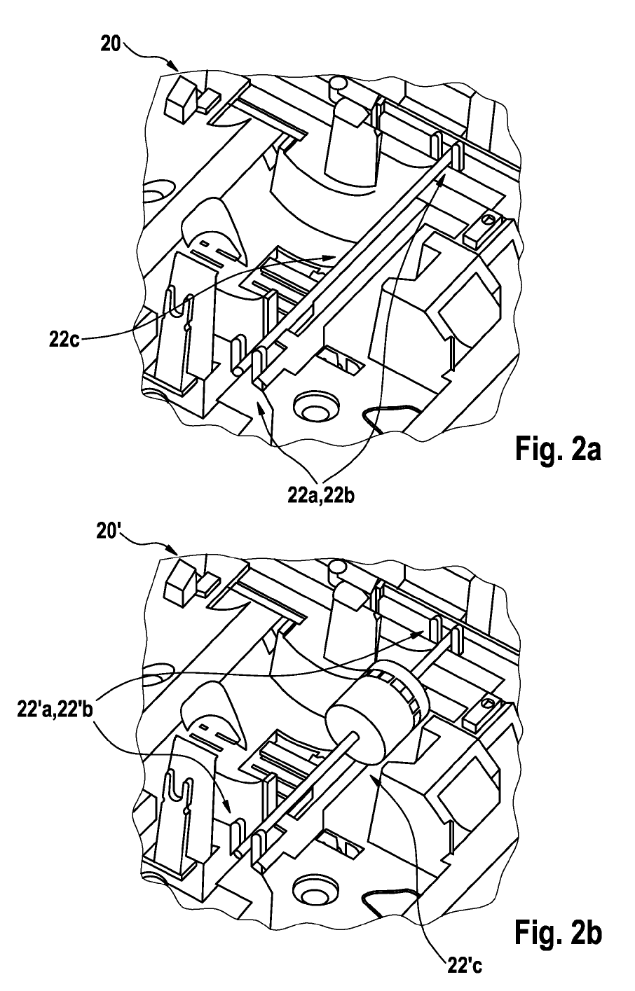

FIG. 2a shows a perspective view on the lower housing part 20 of the control unit 16. Conductor elements 22a, 22b (plus or minus path) can be recognized by which a not further shown conductor printed circuit board is supplied with current. Between the conductor elements 22a, 22b a temperature fuse 22c is arranged, which is construed in the first embodiment according to FIG. 2a as a zinc bridge or fuse wire 22c. The two ends of the temperature fuse 22c can thereby be fixed at the two conductor elements 22a, 22b with the aid of welding, soldering or a cut-clamp connection. If in the case of an error the temperature in the control unit 16 exceeds a critical value, the zinc bridge or the fuse wire 22c melts and the current supply to the control unit 16 is permanently interrupted.

A second embodiment is shown in FIG. 2b, whereby the temperature fuse is construed as bimetal element 22′c in that case. Analogously to the first embodiment the current supply to the control unit 16 is interrupted by the bimetal element 22′c in when exceeding a critical temperature in the control unit 16; when reaching the triggering temperature the electrical contact is separated quickly and erratically by the jumping around of a bimetal disc.

As it has been already been stated in the description summary the invention is not limited to the two embodiments of a control unit for a cooling-air fan of an internal combustion engine, but can be universally used at control units that are used in motor vehicles, at which a battery or supply voltage is permanently is applied.

1-5. (canceled)

6. A control unit for a cooling-air fan of an internal combustion engine with a housing, wherein a printed circuit board for recording electrical components and conductor elements for a current supply are arranged in the housing of the control unit, comprising:
a temperature fuse arranged between the conductor elements as a overheating safeguard for the control unit.

7. The control unit of claim 6, wherein the temperature fuse comprises one of a zinc bridge, a fuse wire, and a bimetal element.

8. The control unit of claim 6, wherein the temperature fuse is fixed at the conductor elements via one of welding, soldering, and a cut-clamp connection.

9. A cooling system for an internal combustion engine of a motor vehicle with a cooling-agent circuit comprising a cooler, a cooling-agent pump, and an electrically controllable cooling-air fan connected with a control unit, wherein the control unit comprises conductor elements for a current supply, comprising:
a temperature fuse arranged between the conductor elements as a overheating safeguard for the control unit.

10. The cooling system of claim 9, wherein the temperature fuse comprises one of a zinc bridge, a fuse wire, and a bimetal element.
